(19) United States
(12) Patent Application Publication
(10) Pub. No.: US 2026/0084927 A1
(43) Pub. Date: Mar. 26, 2026

(54) ALLOWABLE WORK ZONE WITHIN VIRTUAL SAFETY NET SYSTEM

(71) Applicant: Otis Elevator Company, Farmington, CT (US)

(72) Inventors: James Tilsley Auxier, Palm Beach Gardens, FL (US); Randall Roberts, Hebron, CT (US); Kathleen Nicole Moore, West Hartford, CT (US); Bruce W. Horne, Cromwell, CT (US); Jesse R. Richter, West Hartford, CT (US); James Chmiel, Suffield, CT (US)

(21) Appl. No.: 18/896,116

(22) Filed: Sep. 25, 2024

(51) Int. Cl. B66B 5/00; B66B 3/00; B66B 5/02

(52) U.S. Cl. CPC B66B 5/005; B66B 3/002; B66B 5/02

(57) ABSTRACT

A virtual safety net system includes at least one active remove sensor in signal communication with a processor. The at least one remote sensor is configured to output energy that establishes an energy safety net and to detect reflected energy that is reflected from an object disposed in the energy safety net. The energy safety net has a work zone defined within the energy safety net. The processor is configured to determine a location of the object within the energy safety net. The processor determines the object as authorized to be located within the energy safety net when the object is within the work zone, and determines the object as unauthorized to be located within the energy safety net when the object is outside the work zone while remaining within the energy safety net.

### BACKGROUND

The present disclosure relates to conveyance systems and, in particular, to an allowable work zone within an virtual safety net system.

Conveyance systems such as elevators, escalators, etc., may have various hazard areas or zones (e.g., pinch points) that should be treated with safety, but still may require maintenance. Elevator systems, for example, typically have various critical areas or safety areas where mechanics may be required to perform maintenance work on the elevator system. For example, it is common for a mechanic to access the top of the elevator car that includes a landing where a mechanic performs maintenance on the landing door lock assembly and/or door interlocks. It is desirable to monitor these areas to ensure the mechanic resides in a safe environment.

### SUMMARY

According to an aspect of the disclosure, a virtual safety net system includes at least one active remove sensor in signal communication with a processor. The at least one remote sensor is configured to output energy that establishes an energy safety net and to detect reflected energy that is reflected from an object disposed in the energy safety net. The energy safety net has a work zone defined within the energy safety net. The processor is configured to determine a location of the object within the energy safety net. The processor determines the object as authorized to be located within the energy safety net when the object is within the work zone, and determines the object as unauthorized to be located within the energy safety net when the object is outside the work zone while remaining within the energy safety net.

In accordance with additional or alternative embodiments, the processor maintains operation of an elevator system when the object is determined as authorized, and performs a safety action when the object is determined as unauthorized.

In accordance with additional or alternative embodiments, each of first dimensions of the energy safety net and second dimensions of the work zone are dynamically set.

In accordance with additional or alternative embodiments, the first and second dimensions are input to the processor, and wherein the processor controls the at least one active remote sensor to generate the energy safety net having the work zone according to the first and second dimensions.

In accordance with additional or alternative embodiments, the energy safety net includes a warning track surrounding at least a portion of the work zone.

In accordance with additional or alternative embodiments, the processor generates an alert prior to disabling the elevator system when the object is located within the warning track.

In accordance with additional or alternative embodiments, third dimensions defining the warning track are input to the processor, and the processor controls the at least one active remote sensor to generate the energy safety net having the work zone and the warning track according to the first, second and third dimensions.

In accordance with additional or alternative embodiments, the energy safety net having the work zone defines a two-dimensional (2D) area of interest (AOI).

In accordance with additional or alternative embodiments, the energy safety net having the work zone defines a three-dimensional (3D) volume of interest (VOI).

In accordance with additional or alternative embodiments, the safety action includes generating one or both of an alert and activating an elevator safety chain of the elevator system.

According to another non-limiting embodiment, a method of operating a virtual safety net system is provided. The method comprises inputting into a processor first dimensions of an energy safety net, and inputting into the processor second dimensions of a work zone located within the energy safety net. The method further includes outputting, from at least one active remote sensor, energy to establish the energy safety net having the work zone, detecting reflected energy that is reflected from an object disposed in the energy safety net, and determining a location of the object within the energy safety net based on the energy that is reflected. The method further comprises determining the object as authorized to be located within the energy safety net when the object is within the work zone, or determining the object as unauthorized to be located within the energy safety net when the object is outside the work zone while remaining within the energy safety net.

In accordance with additional or alternative embodiments, the method further includes maintaining operation of an elevator system when the object is determined as authorized, and performing a safety action when the object is determined as unauthorized.

In accordance with additional or alternative embodiments, the method further includes dynamically setting each of first dimensions of the energy safety net and second dimensions of the work zone.

In accordance with additional or alternative embodiments, the method further includes inputting the first and second dimensions into the processor; and controlling, by the processor controls, the at least one active remote sensor to generate the energy safety net having the work zone according to the first and second dimensions.

In accordance with additional or alternative embodiments, the method further includes establishing a warning track that surrounds at least a portion of the work zone included in the energy safety net.

In accordance with additional or alternative embodiments, the method further includes generating an alert prior to disabling the elevator system in response to the object being located within the warning track.

In accordance with additional or alternative embodiments, the method further includes inputting third dimensions defining the warning track into the processor, controlling, by the processor, the at least one active remote sensor to generate the energy safety net having the work zone and the warning track according to the first, second and third dimensions.

In accordance with additional or alternative embodiments, the energy safety net having the work zone defines a two-dimensional (2D) area of interest (AOI).

In accordance with additional or alternative embodiments, the energy safety net having the work zone defines a three-dimensional (3D) volume of interest (VOI).

In accordance with additional or alternative embodiments, the safety action includes generating one or both of an alert and activating an elevator safety chain of the elevator system.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an elevator system according to a non-limiting embodiment;

FIG. 2 is a perspective view of a top of an elevator car included in the elevator system shown in FIG. 1 according to a non-limiting embodiment;

FIG. 3 illustrates the top of the elevator car of FIG. 2 showing an area of interest covered by an infrared safety net system according to a non-limiting embodiment;

FIG. 4 illustrates the elevator safety net system of FIG. 3 implementing a dynamically defined allowable work zone according to a non-limiting embodiment;

FIG. 5 illustrates the elevator safety net system of FIG. 3 showing the allowable work zone having a dynamically set warning track according to a non-limiting embodiment; and

FIG. 6 is a flow diagram illustrating a method of operating an elevator safety net system according to a non-limiting embodiment.

### DETAILED DESCRIPTION

Conveyance systems such as elevators, escalators, moving walkways, etc., may include multiple monitors and sensors are provided to monitor various parts, components, and/or hazard areas. In elevator systems, for example, sensor may and monitors may be utilized to monitor the elevator pit, which service technicians and mechanics enter to perform maintenance and service tasks, the pit ladder, which service technicians and mechanics use to access the elevator pit and to stand on during some operations. Sensors may also be utilized to monitor elevator top of car areas above the protective handrails, which mechanics use to access the elevator hoistway. A cost-effective way of detecting a person, such as a service technician or a mechanic, standing in the elevator pit or on the pit ladder or leaning over the elevator top of car handrails of an elevator system is therefore needed. Such a detection system needs to be easy to install and adjust and needs to require minimal service and maintenance. The detection system must also have high detection performance with low false positive and negative outcomes. In addition, when a detection system is installed, it is important that there be a verification process in place to ensure the detection system is operating properly and can be trusted to detect service technicians and mechanics in hazardous locations in the elevator pit and on the pit ladder. This verification process should be simple to initiate and use and effective to thereby provide installation personnel adequate data to allow them to confidently turn over the detection system.

Active remote elevator sensor safety systems, sometimes referred to as an energy safety net system, a virtual safety net system, or when employed in an elevator system an “elevator safety net system” have recently been implemented to monitor critical area of interest (AOI) and/or volume of interest (VOI) of an elevator system such as, for example, the elevator pit, the elevator pit ladder, and the handrails located at the top of the elevator car (i.e., a car top). The safety net system includes one or more active remote sensors, disposed at the critical areas of the elevator system to be monitored, i.e., an AOI. An active remote sensor such as a Light Detection and Ranging (LiDAR) sensor, for example, is configured to output an energy signal (e.g., laser light) and to measure the intensity of the reflected energy that is reflected from an object on which the energy signal impinges. However, there are times when maintenance procedures that would otherwise cause the elevator system net system to generate an alarm and disable operation must instead allow the elevator system to continue operating while maintenance procedures are safely performed as the elevator safety net system continues monitoring the critical AOI. For example, a pinch hazard may exist where a mechanics hands or fingers can be pinched between the elevator car and the floor landing during operation of the elevator car. Therefore, an elevator safety net system would typically sense a mechanics hands or object in the plane and therefore disable to the elevator system to prevent movement of the elevator car and avoid the pinching hazard. However, a mechanic may need to perform maintenance on the landing door lock assembly, and in doing so is typically required to operate the elevator car while performing the maintenance.

Various non-limiting embodiments of the present disclosure provide an elevator safety net system that monitors an AOI and implements a dynamically defined allowable work zone within the AOI. When an object is detected within the allowable work zone the object is permitted to remain within the AOI without performing a safety action (e.g., without generating an alert and/or disabling the elevator system). In this manner, mechanics can access safety critical areas of interest to perform maintenance work without comprising the safety monitoring performed by the elevator safety net system. When, however, the object is not located within the allowable work zone but still within the 2D plane or 3D space, a safety action is performed (e.g., generating an alert and/or disabling the elevator system) to protect the safety of the mechanic.

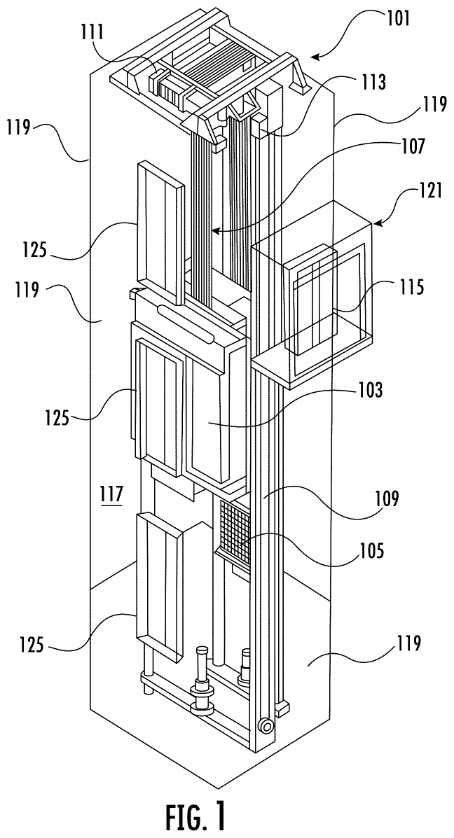

With reference to FIG. 1, which is a perspective view of an elevator system 101, the elevator system 101 includes an elevator car 103, a counterweight 105, a tension member 107, a guide rail 109, a machine 111, a position reference system 113 and a controller 115. The elevator car 103 is disposed in an elevator shaft 117 defined by surrounding shaft walls 119. The elevator car 103 and the counterweight 105 are connected to each other by the tension member 107. The tension member 107 may include or be configured as, for example, ropes, steel cables and/or coated-steel belts. The counterweight 105 is configured to balance a load of the elevator car 103 and is configured to facilitate movement of the elevator car 103 concurrently and in an opposite direction with respect to the counterweight 105 within the elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the elevator shaft 117 or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more floor landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be integrally attached to the elevator car 103 or the elevator door 104 may be located on a floor landing 125 of the elevator system 101, or both. Embodiments disclosed herein may be applicable to both an elevator door 104 integrally attached to the elevator car 103 or an elevator door 104 located on a floor landing 125 of the elevator system 101, or both. The elevator door 104 opens to allow passengers to enter and exit the elevator car 103. The elevator system 101 further includes a “safety chain”. Accordingly, activating the safety chain can cut power and/or otherwise deactivate the conveyance system. When utilizing an elevator safety chain, for example, invoking the safety chain deactivates the elevator motor and activates elevator brakes to bring the elevator car 103 to a safe stop in the event of some detected failure or safety-related condition.

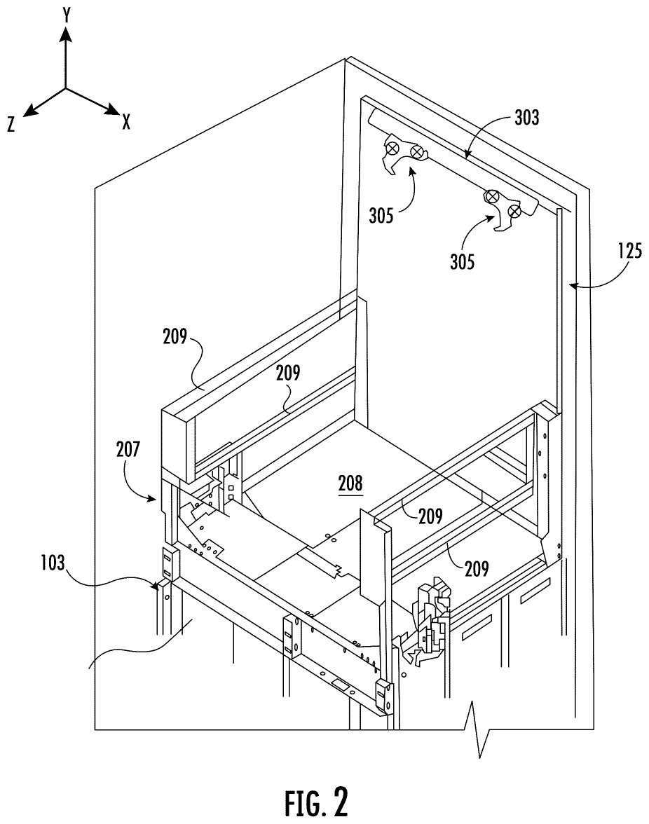

With continued reference to FIG. 1 and with additional reference to FIG. 2, a top 207 of the elevator car 103 (i.e., a car top 207) included in the elevator system 101 is illustrated. The elevator car 103 is surrounded by one or more shaft walls 119 and can travel vertically therein to service one or more floor landings 125. The car top 207 includes a top landing 208 and one or more handrails 209 that surround, or partially surround, the top landing 208. In this example, the top landing 208 provides access to a landing door lock assembly 303 that includes one or more door interlocks 305 located atop a corresponding landing 125.

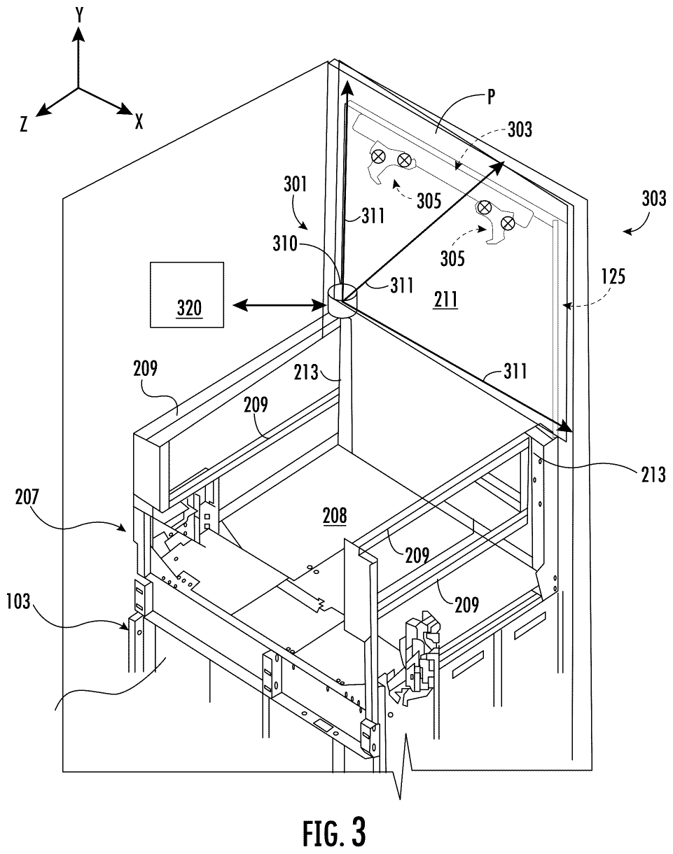

Turning to FIG. 3, an elevator safety net system 301 is installed on the car top 207. The elevator safety net system 301 includes a sensor 310 and a processor 320. The elevator safety net system 301 is provided to reliably identify whether an unauthorized object is located in an AOI 211. In this example, the AOI 211 is an area that extends beyond the top landing 208 and includes the landing door lock assembly 303. When an unauthorized object is detected within the AOI 211, the elevator safety net system 301 can perform a safety action such as, for example, generating an alert (e.g., sound alert, light alert, etc.) and/or disabling the elevator system 101. It should be appreciated that the designated AOI 211 between the top landing 208 and the floor landing 125, including the landing door lock assembly 303, is just one example and other AOIs 211 can be monitored by the elevator safety net system 301 without departing from the scope of the invention.

In the example shown in FIG. 3, the sensor 310 is implemented as an active remote sensor 310 (e.g., a LiDAR sensor) and is arranged in a plane (P). The sensor 310 can be adjusted so that the plane (P) extends between the top landing 208 and the floor landing 125 so that the plane (P) covers the AOI 211. As described herein, the AOI 211 includes the landing door lock assembly 303, but it should be appreciated that other AOIs 211 can be monitored without departing from the scope of the invention. In this example, the plane (P) can be defined as: (x₁, y₁); (x₂, y₁); (x₁, y₂); and (x₂, y₂). Although 2D Cartesian coordinates are described, it should be appreciated that 3D coordinates can be used when the sensor is implemented as a 3D sensors (e.g., a 3D LiDAR). In addition, the shape and profile is not limited to a rectangular or square, but rather can include any shape or profile defined by the input data. In any case, the coordinates can be dynamically input to the processor 320 manually or pre-set within the processor 320. In this manner, the processor 320 can determine the coordinates and identify the location of the plane (P) accordingly.

The sensor 310 is configured to perform sensing to sense an object that is disposed the plane (P). When an object is located in the plane (P), the processor 320 can generate data corresponding to results of the sensing, e.g., an indication that an object is located in the plane (P) and/or the shape and profile of the object. Although a single sensor 310 is shown, it should be appreciated that additional sensors 310 can be implemented without departing from the scope of the present disclosure.

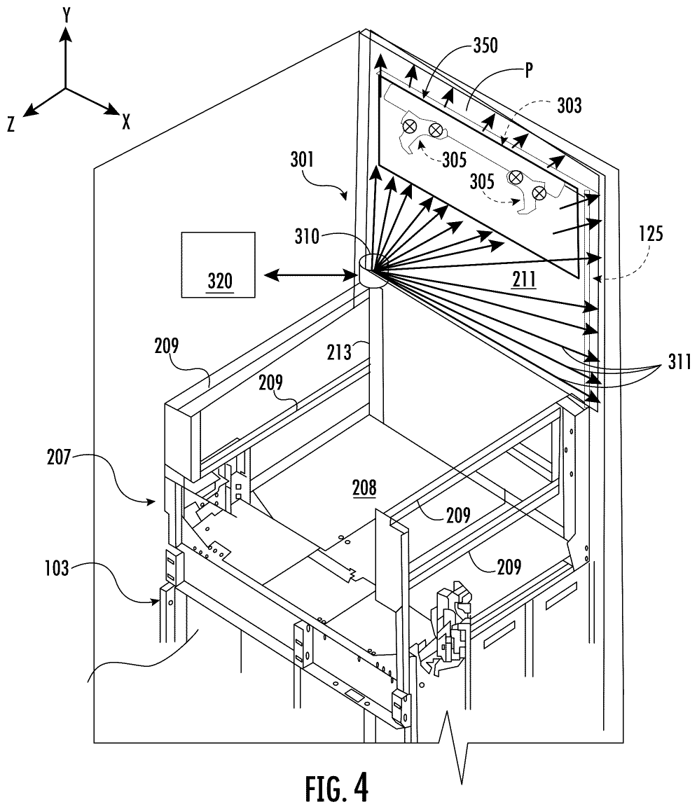

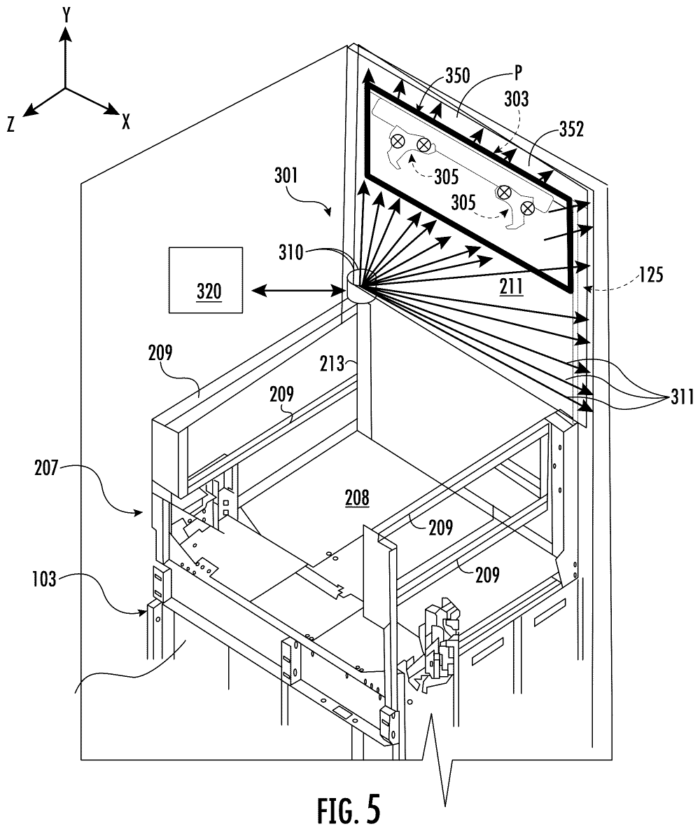

The processor 320 includes a processing unit, a memory, an input/output (I/O) unit by which the processor 320 is communicative with the sensor 310, and at least a main controller (e.g., controller 115). The memory has executable instructions and software stored thereon, which are readable and executable by the processing unit. When the processor 320 reads and executes the executable instructions and/or software, the processor 320 is commanded to operate as described herein. In accordance with embodiments, the memory can also store coordinates or dimensions defining the shape and profile of an IR energy 2D plane or 3D space established by the sensor 310, coordinates or dimensions defining the shape and profile of an allowable work zone (see FIG. 4), and coordinates or dimensions defining the shape and profile of a warning track (see FIG. 5).

The processor 320 can be remote from the sensor 310 or local to the sensor 310. In the former case, the processor 320 can be operably coupled to the sensor 310 via a wired connection or via a wireless connection. In the latter case, the processor 320 can be built into the sensor 310 (e.g., integrated) or provided as a separate component from the sensor 310 and operably coupled to the sensor 310 via a wired connection or via a wireless connection. In one or more non-limiting embodiments, processor 320 can also read car motion status from a switch or a controller (e.g., controller 115) to determine if the elevator car 103 is moving. If so, the elevator system 101 can perform a “disable” reaction when a person is detected, an/or an alert can be generated.

In accordance with embodiments, the sensor 310 can include or be provided as one or more of a light detection and ranging or a laser imaging, detection, and ranging (LiDAR) sensor, a radio detection and ranging (RADAR) sensor, infrared (IR) sensors, and/or a camera. In accordance with further embodiments, the sensor 310 can be provided as one or more of a two-dimensional (2D) LiDAR sensor, a three-dimensional (3D) LiDAR sensor, a millimeter wave RADAR sensor and/or a red, green, blue, depth (RGBD) camera. In accordance with still further embodiments, the sensor 310 can be provided as plural sensors including a combination of one or more sensor types listed herein.

The sensor 310 (e.g., a 2D LiDAR) emits energy 311 (e.g., IR energy or laser pulses) to establish an energy safety net. In this example, the IR energy 311 is emitted along plane (P) to provide an IR energy plane (P) that covers the AOI 211. It should be appreciated that although a 2D plane (P) is described in FIG. 2, the sensor 310 can emit IR energy 311 that defines a 3D IR energy space when implementing the sensor 310 as, for example, a 3D LiDAR sensor. According to a non-limiting embodiment, the AOI or volume of interest (VOI) can be set during the installation step based on the particular dimensions of the critical area or hazard area to be monitored. (either on top-of-car, pit ladder or pit area). This allows proper orientation and projection of the energy safety net according to a specific arrangement and geometry embodiment. Once set, the projected IR energy 311 can generate point cloud data using a single scan for image processing, multiple scans for image processing and/or multiple successive or continuous scans for video processing. As described herein, the processor 320 can generate a safety action when an object crosses the plane (P) and is located in the AOI 211. The safety action includes, for example, generating an alert and/or disabling the elevator system 101.

Turning to FIG. 4, the elevator safety net system 301 is shown after setting an allowable work zone 350 within the IR energy plane (P) according to a non-limiting embodiment. The allowable work zone 350 can be dynamically set by inputting into the processor 320 the desired dimensions of the allowable work zone 350 with respect to the dimensions of the plane (P). For example, when the dimensions of the plane (P) are defined as (x₁, y₁), (x₂, y₁), (x₁, y₂) and (x₂, y₂), the dimensions of the allowable work zone 350 can be defined as (x′₁, y′₁), (x′₂, y′₁), (x′₁, y′₂) and (x′₂, y′₂). As described herein, the shape and profile of the plane (P) is not limited to a rectangular or square, but rather can include any shape or profile defined by the input data and/or 3D coordinates can be used when the sensor 310 is implemented as a 3D sensor (e.g., a 3D LiDAR). In one more non-limiting embodiments, the dimensions of the allowable work zone 350 can be changed at any time, thus providing an allowable work zone 350 that can be dynamically adjusted (i.e., a “dynamic allowable work zone” 350).

The allowable work zone 350 solves this problem because the processor 320 is programmed with its dimensions with respect to the set dimensions of the IR energy plane (P). Therefore, the processor 320 can detect whether an object disposed in the AOI 211 defined by the plane (P) is located within the allowable work zone 350, or is located within the AOI 211, but outside of the allowable work zone 350. For example, when an object is detected within the IR energy plane (P), the processor 320 determines whether the object is located within the allowable work zone 350. When the object is located within the allowable work zone 350, the processor 320 refrains from performing a safety action (e.g., refrains from generating an alert and/or disabling the elevator system 101), thereby permitting the object to remain within the AOI 211. When, however, the object is not located within the allowable work zone 350 (but still within the plane), the processor 320 performs a safety action (e.g., generating an alert and/or disabling the elevator system 101). In this manner, a mechanic can access a particular component or assembly (e.g., landing door lock assembly 303 and/or door interlock 305) located within an AOI 211, while still afforded operation of the elevator car 103 in order to complete the maintenance.

FIG. 5 illustrates the elevator safety net system 301 according to another non-limiting embodiment. In this example, the allowable work zone 350 is generated with an additional warning track 352 that surrounds the perimeter of the allowable work zone 350. The warning track 352 can serve as a warning indicator that alerts a mechanic prior to disabling the elevator system 101 that they are leaving the allowable work zone 350 (e.g., their hand or a tool they are holding is leaving the allowable work zone 350) and about to enter the surrounding IR energy plane (P). The warning track 352 can be set by inputting its dimensions with respect to the allowable work zone 350. For example, when the dimensions of the plane (P) are defined as (x′1, y′1), (x′2, y′1), (x′1, y′2) and (x′2, y′2), the dimensions of the warning track 352 can be defined as (x″1, y′1), (x″2, y′1), (x″1, y′2) and (x″2, y″2). As described herein, the shape and profile of the warning track 352 is not limited to a rectangular or square, but rather can include any shape or profile defined by the input data and/or 3D coordinates can be used when the sensor is implemented as a 3D sensors (e.g., a 3D LiDAR). When the processor 320 detects an object located in the warning track 352, it can generate an alert (e.g., audio alert, visual alert, haptic alert, etc.) so that the mechanic can readjust their position and avoid disabling the elevator system 101.

Although the examples above employ the elevator safety net system 301 on the top 207 of an elevator car 103 with an allowable work zone 350 to permit maintenance on a landing door lock assembly 303, it should appreciated that the elevator safety net system 301 and allowable work zone 350 can utilized in other areas of the elevator system 101 without departing from the scope of the invention. For example, the elevator safety net system 301 can be employed in the elevator pit 201 to monitor the pit floor while the allowable work zone 350 can be used to allow maintenance on specific cables, ropes, etc. located in the elevator pit. The safety net configuration systems described herein are also not limited to elevator systems, but can be employed in other types of conveyance systems including, but not limited to, escalator systems and moving walkways. Additional sensing in these or other cases can also alternate sensing (mmWave or RGB-D cameras), two or more sensors, coverage of different plans with 2D sensors and ranges of data/image processing approaches, including but not limited to image classification, machine learning, pattern recognition, etc.

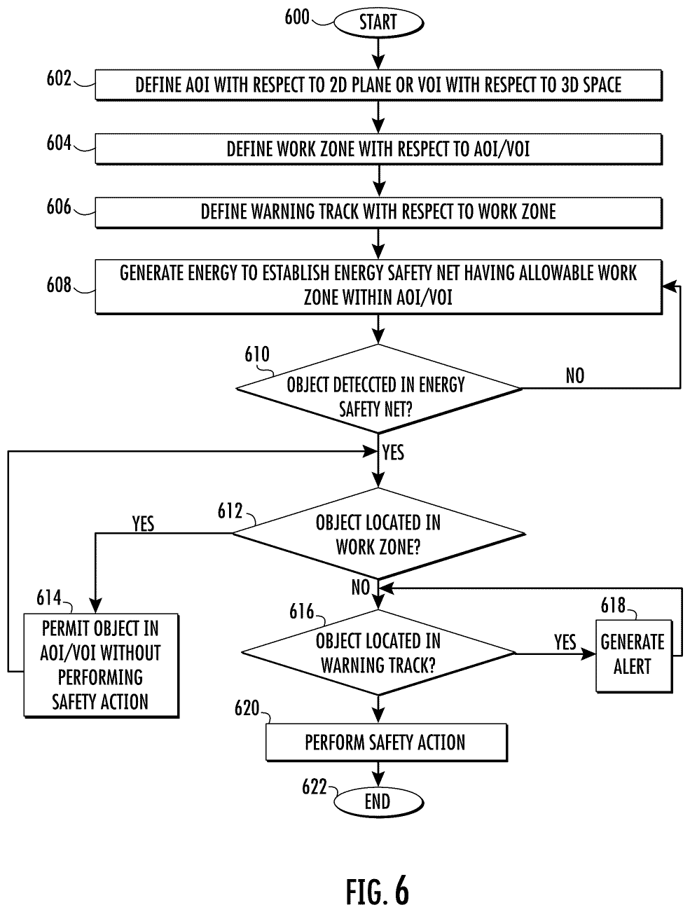

Referring now to FIG. 6, a method of operating an elevator safety net system is illustrated according to a non-limiting embodiment of the present disclosure. The method begins at operation 600, and an AOI or a VOI is defined at operation 602. The AOI can be defined with respect to a 2D plane, while the VOI can be defined with respect to a 3D space defined by energy generated by a sensor is determined at operation 602. At operation 604, an allowable work zone within the AOI or VOI is dynamically defined and set. According to a non-limiting embodiment, the dimensions can be dynamically defined and set in the software of a processor (e.g., processor 320). In this manner, the dimensions of the allowable work zone can be dynamically changed at any time should the AOI change and/or to accommodate a different working area located in the AOI. At operation 606, a warning track is defined with respect to the work zone is define and set in the software of a processor (e.g., processor 320). According to a non-limiting embodiment, the warning track surrounds one or more portions of the work zone permitter. At operation 608, energy is generated by the sensor to establish an energy safety net, which has a profile defined by the AOI/VOI and which includes an allowable work zone defined by the dynamically set work zone.

Turning to operation 610, a determination is made (e.g., by processor 320) as to whether an object is located in the AOI/VOI. When no object is detected, the method returns to operation 608 and continues generating the energy. When an object is detected within the AOI/VOI, however, a determination is made as to whether the object is located within the allowable work zone at operation 612. When the object is located within the allowable work zone, the object is permitted to remain within the AOI without performing a safety action (e.g., without generating an alert and/or disabling the elevator system) at operation 614, and the method returns to operation 612 to continue monitoring whether the object is located in the allowable work zone. In this manner, mechanics can access safety critical areas of interest to perform maintenance work without comprising the safety monitoring performed by the elevator safety net system.

When, at operation 612, the object is not located within the allowable work zone (but still within the AOI/VOI), a determination is made at operation 616 as to whether the object is located in the warning track. When the object is located in the warning track, an alert (e.g., an audio alert, visual alert, haptic alert, etc.) is generated at operation 618, and the method returns to operation 616 to continue monitoring whether the object is located in the warning track. When, at operation 616, the object is not located in the warning track, a safety action (e.g., generating an alert and/or disabling the elevator system, activating the safety chain, etc.) is performed at operation 620, and the method ends at operation 622.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A virtual safety net system comprising:
at least one active remote sensor configured to output energy that establishes an energy safety net and to detect reflected energy that is reflected from an object disposed in the energy safety net, the energy safety net having a work zone defined within the energy safety net; and
a processor in signal communication with the at least one active remote sensor, the processor configured to determine a location of the object within the energy safety net,
wherein the processor determines the object as authorized to be located within the energy safety net when the object is within the work zone, and determines the object as unauthorized to be located within the energy safety net when the object is outside the work zone while remaining within the energy safety net.

2. The virtual safety net system of claim 1, wherein the processor maintains operation of an elevator system when the object is determined as authorized, and performs a safety action when the object is determined as unauthorized.

3. The virtual safety net system of claim 1, wherein each of first dimensions of the energy safety net and second dimensions of the work zone are dynamically set.

4. The virtual safety net system of claim 3, wherein the first and second dimensions are input to the processor, and wherein the processor controls the at least one active remote sensor to generate the energy safety net having the work zone according to the first and second dimensions.

5. The virtual safety net system of claim 3, wherein the energy safety net includes a warning track surrounding at least a portion of the work zone.

6. The virtual safety net system of claim 5, wherein the processor generates an alert prior to disabling the elevator system when the object is located within the warning track.

7. The virtual safety net system of claim 6, wherein third dimensions defining the warning track are input to the processor, and wherein the processor controls the at least one active remote sensor to generate the energy safety net having the work zone and the warning track according to the first, second and third dimensions.

8. The virtual safety net system of claim 1, wherein the energy safety net having the work zone defines a two-dimensional (2D) area of interest (AOI).

9. The virtual safety net system of claim 1, wherein the energy safety net having the work zone defines a three-dimensional (3D) volume of interest (VOI).

10. The virtual safety net system of claim 2, wherein the safety action includes generating one or both of an alert and activating an elevator safety chain of the elevator system.

11. A method of operating a virtual safety net system, the method comprising:
inputting into a processor first dimensions of an energy safety net;
inputting into the processor second dimensions of a work zone located within the energy safety net;
outputting, from at least one active remote sensor, energy to establish the energy safety net having the work zone;
detecting reflected energy that is reflected from an object disposed in the energy safety net;
determining a location of the object within the energy safety net; and
determining the object as authorized to be located within the energy safety net when the object is within the work zone, or determining the object as unauthorized to be located within the energy safety net when the object is outside the work zone while remaining within the energy safety net.

12. The method of claim 11, further comprising:
maintaining operation of an elevator system when the object is determined as authorized, and
performing a safety action when the object is determined as unauthorized.

13. The method of claim 11, further comprising dynamically setting each of first dimensions of the energy safety net and second dimensions of the work zone.

14. The method of claim 13, further comprising:
inputting the first and second dimensions into the processor; and
controlling, by the processor controls, the at least one active remote sensor to generate the energy safety net having the work zone according to the first and second dimensions.

15. The method of claim 13, further comprising establishing a warning track that surrounds at least a portion of the work zone included in the energy safety net.

16. The method of claim 15, further comprising generating an alert prior to disabling the elevator system in response to the object being located within the warning track.

17. The method of claim 16, further comprising:
inputting third dimensions defining the warning track into the processor; and
controlling, by the processor, the at least one active remote sensor to generate the energy safety net having the work zone and the warning track according to the first, second and third dimensions.

18. The method of claim 11, wherein the energy safety net having the work zone defines a two-dimensional (2D) area of interest (AOI).

19. The method of claim 11, wherein the energy safety net having the work zone defines a three-dimensional (3D) volume of interest (VOI).

20. The method of claim 12, wherein the safety action includes generating one or both of an alert and activating an elevator safety chain of the elevator system.
